(19) United States
(12) Patent Application Publication
(10) Pub. No.: US 2006/0098844 A1
(43) Pub. Date: May 11, 2006

(54) Object detection utilizing a rotated version of an image

(76) Inventor: Huitao Luo, Fremont, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/981,486

(22) Filed: Nov. 5, 2004

(51) Int. Cl. G06K 9/00; G06K 9/46

(52) U.S. Cl. 382/103; 382/190

(57) ABSTRACT

A method for detecting a predetermined object in an image includes detecting a potential predetermined object in the image. In the method, at least one portion of the image is rotated and it is determined as to whether the potential predetermined object is detected in the rotated at least one portion of the image. Moreover, it is determined whether the potential predetermined object is an accurate detection of the predetermined object in response to a determination of whether the potential predetermined object is detected in the rotated at least one portion of the image.

### BACKGROUND

Most state-of-the-art object detection algorithms are capable of detecting upright, frontal views of various objects. In addition, some of these algorithms are also capable of detecting objects with moderate in-plane rotations. However, the detection performance of these algorithms is difficult or otherwise impracticable to improve once the detection algorithm is fixed. In other words, the detection rate cannot be improved without increasing the false alarm rates associated with the use of these algorithms. The performance of these object detection algorithms is also limited by the capacity of its fundamental classifier. More particularly, traditional detection algorithms are incapable of improving their detection rates without also increasing their false alarm rates and vice versa, once the capacity of the classifier is reached.

Accordingly, it would be desirable to be able to detect objects with relatively high detection rates and relatively low false alarm rates.

### SUMMARY OF THE INVENTION

A method for detecting a predetermined object in an image is disclosed. In the method, a potential predetermined object in the image is detected. In addition, at least one portion of the image is rotated and it is determined as to whether the potential predetermined object is detected in the rotated at least one portion of the image. Moreover, it is determined whether the potential predetermined object is an accurate detection of the predetermined object in response to a determination of whether the potential predetermined object is detected in the rotated at least one portion of the image.

### BRIEF DESCRIPTION OF THE DRAWINGS

Features of the present invention will become apparent to those skilled in the art from the following description with reference to the figures, in which:

FIG. 1A shows a block diagram of an object detection system according to an embodiment of the invention;

FIG. 1B shows a block diagram of an object detection system, according to another embodiment of the invention;

FIG. 2 illustrates a flow diagram of an operational mode of a method for detecting objects in images, according to an embodiment of the invention;

FIG. 3 illustrates a flow diagram of an operational mode of a method for detecting objects in images, according to another embodiment of the invention;

FIG. 4 illustrates a flow diagram of an operational mode of a method for detecting objects in images, according to a further embodiment of the invention; and

FIG. 5 illustrates a computer system, which may be employed to perform the various functions of object detection systems described hereinabove, according to an embodiment of the invention.

### DETAILED DESCRIPTION OF THE INVENTION

For simplicity and illustrative purposes, the present invention is described by referring mainly to an exemplary embodiment thereof. In the following description, numerous specific details are set forth in order to provide a thorough understanding of the present invention. It will be apparent however, to one of ordinary skill in the art, that the present invention may be practiced without limitation to these specific details. In other instances, well known methods and structures have not been described in detail so as not to unnecessarily obscure the present invention.

Spatial filtering algorithms are disclosed herein to improve the performance of various object detection algorithms. In general, the spatial filtering algorithms are designed to boost performance of the various object detection algorithms by leveraging upon the spatial redundancies between multiple rotated versions of an image. In addition, the spatial filtering algorithms are not linked to any specific type of object detection algorithm, and thus, may be employed with a number of different object detection algorithms.

In other words, the spatial filtering algorithms disclosed herein are designed to accurately detect objects, such as, for instance, human faces, automobiles, household products, etc., through generation and evaluation of multiple rotated versions of one or more images. In one respect, the spatial filtering algorithms may determine in which of the rotated versions the same objects are detected. If the same detected objects appear in multiple ones of the rotated versions of an image, there is a relatively high probability that the potential detected objects are the actual objects in the image. Alternatively, if a potential detected object does not appear in at least one of the multiple rotated versions, there is a relatively high probability that the potential detected object is not the desired object, and thus, may be disregarded. In this regard, through implementation of the spatial filtering algorithms disclosed herein, the detection rates of various object detection algorithms may be improved without also increasing their false alarm rates.

The spatial filtering algorithms disclosed herein may have relatively broad applicability and may thus be employed with a wide variety of object detection algorithms. For instance, these spatial filtering algorithms may be employed with object detection algorithms having applications in face based content analysis, human identification management, image quality evaluation, artificial intelligence, etc.

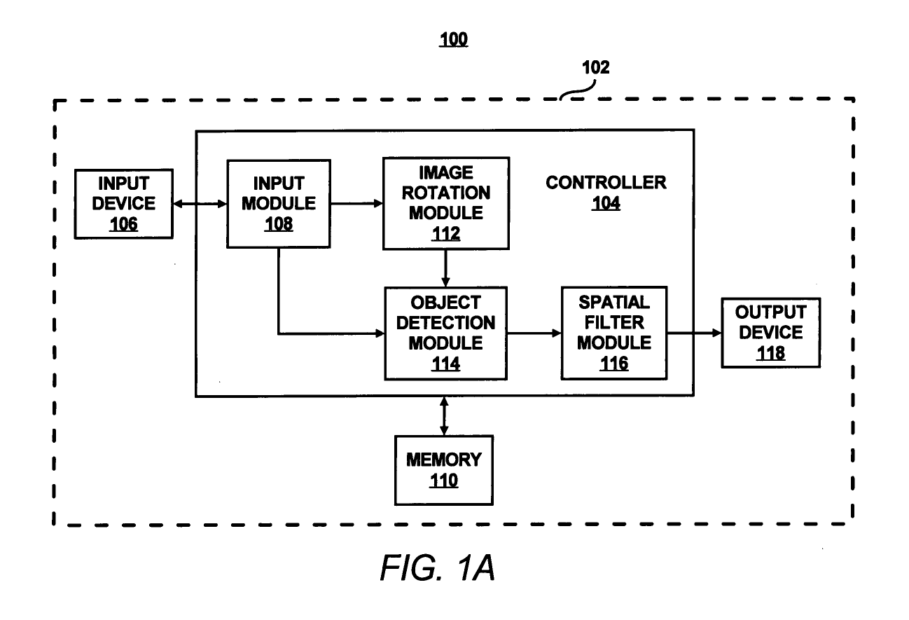

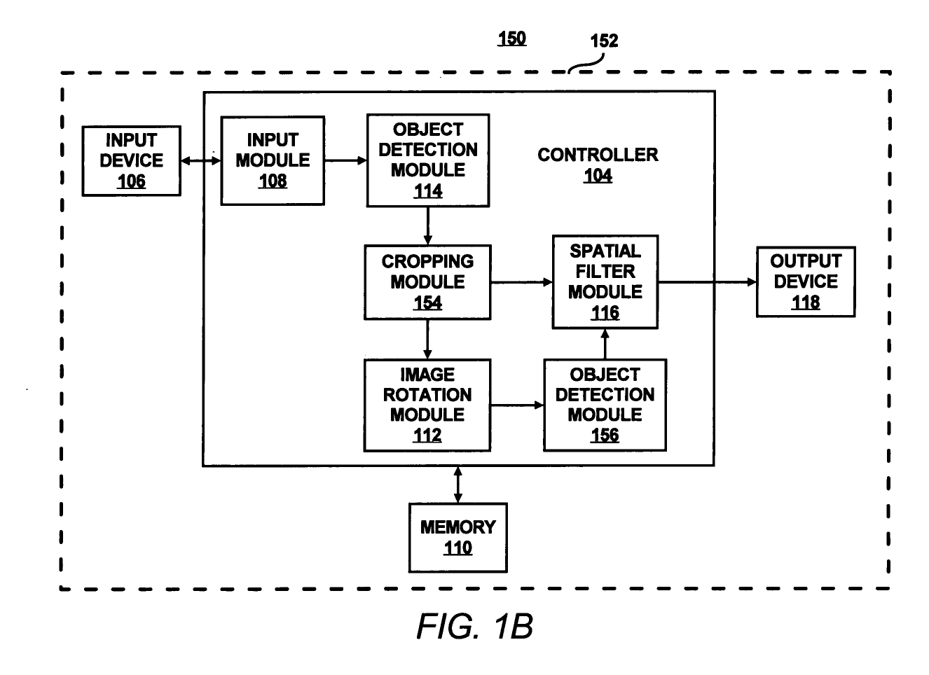

With reference first to FIG. 1A, there is shown a block diagram 100 of an object detection system 102. It should be understood that the following description of the block diagram 100 is but one manner of a variety of different manners in which such an object detection system 102 may be configured. In addition, it should be understood that the object detection system 102 may include additional elements and that some of the elements described herein may be removed and/or modified without departing from a scope of the object detection system 102. For instance, the object detection system 102 may include additional input devices, output devices, memories, modules, etc.

The object detection system 102 includes a controller 104 configured to perform various functions of the object detection system 102. In this regard, the controller 104 may comprise a computing device, for instance, a computer system, a server, etc. In addition, the controller 104 may comprise a microprocessor, a micro-controller, an application specific integrated circuit (ASIC), and the like, configured to perform various processing functions.

The controller 104 may be interfaced with an input device 106 configured to supply the controller 104 with information, such as, for instance, image data. The input device 106 may comprise a machine in a computing device in which the controller 104 is housed. In this regard, the input device 106 may comprise a storage device, such as, a CD-ROM drive, a floppy diskette drive, compact flash memory reader, etc. In addition, or alternatively, the input device 106 may comprise a device separate from the controller 104 as pictured in FIG. 1A. In this regard, for instance, the input device 106 may comprise an external drive, a camera, a scanning machine, an interface with an internal network or the Internet, etc.

In any event, the controller 104 may receive image data from the input device 106 through an input module 108. The input module 108 may comprise one or more drivers for enabling communications and data transfer from the input device 106 to the controller 104. In addition, the controller 104 may be configured to communicate and transfer data back to the input device 106 to thereby control certain operations of the input device 106. Thus, for instance, the controller 104 may transmit communications to the input device 106 to thereby receive the image data. The controller 104 may communicate with the input device 106 via an Ethernet-type connection or through a wired protocol, such as IEEE 802.3, etc., or wireless protocols, such as IEEE 802.11b, 802.11g, wireless serial connection, Bluetooth, etc., or combinations thereof.

The image data received from the input device 106 may be stored in a memory 110 accessible by the controller 104. The memory 110 may comprise a traditional memory device, such as, volatile or non-volatile memory, such as DRAM, EEPROM, flash memory, combinations thereof, and the like. The controller 104 may store the image data in the memory 110 so that the image data may be retrieved for future manipulation and processing as disclosed in greater detail herein below. In addition, the memory 110 may store software, programs, algorithms, and subroutines that the controller 104 may access in performing the various object detection algorithms as described herein below.

Also shown in FIG. 1A is an image rotation module 112 configured to manipulate the image data such that the image formed by the image data may be rotated. Although the image rotation module 112 is depicted as being included in the controller 104, the image rotation module 112 may comprise an algorithm stored in the memory 110, which the controller 104 may access and execute. In addition, the image rotation module 112 may comprise other software or hardware configured to perform the above-described functions. In any regard, the image rotation module 112 may be programmed to rotate the image formed by the image data to one or more angles with respect to the original image. Thus, for instance, the image rotation module 112 may be configured to rotate the image in an in-plane direction in increments of about 1 to 5° from the original orientation of the image in either clockwise or counterclockwise directions. The number of image rotation increments may be based, for instance, upon the desired level of accuracy in detecting objects. Thus, the greater the number of image rotation increments, the greater the level of accuracy in detecting objects. However, in certain instances, images that are rotated to a relatively high angle may actually reduce the accuracy in detecting objects due to the possibility that an object detection module 114 may be unable to accurately detect the objects in these rotated images. In this regard, the number of image rotation increments may be determined based on the specific detection feature of the underlying object detection module 114 and may, for instance, be around 1-5 increments.

The object detection system 102 is also illustrated as including the object detection module 114, which is configured to detect predetermined objects in the image formed by the image data. Again, although the object detection module 114 is depicted as being included in the controller 104, the object detection module 114 may comprise an algorithm stored in the memory 110, which the controller 104 may access and execute. In addition, the object detection module 114 may comprise any reasonably suitable conventional algorithm capable of detecting objects in images. By way of example, the objection detection module 114 may comprise a Viola and Jones algorithm. The object detection module 114 may further comprise other software or hardware configured to perform the above-described functions.

The controller 104 may employ the object detection module 114 to detect predetermined objects in the original image as well as in the images that have been rotated by the image rotation module 112. In addition, or alternatively, the object detection module 114 may use different parameter configurations of the same algorithm, or even different algorithms to process images rotated to different angles. The images, with the detected locations of the potential objects, may be inputted into a spatial filter module 116. The spatial filter module 116 may comprise an algorithm stored in the memory 110 that may be accessed and executed by the controller 104. In addition, the spatial filter module 116 may comprise other software or hardware configured to perform the functions of the spatial filter module 116 described herein.

The spatial filter module 116 generally operates to compare the images, two or more of the rotated and original images, to determine which of the images contain the detected objects. If the objects are detected in a plurality of images, for instance, in both the original image and a rotated image or in multiple rotated images, the spatial filter 116 may output an indication that the objects have been accurately detected. However, for greater accuracy, the spatial filter module 116 may compare a plurality of rotated images, and in certain instances, the original image, to determine which of the rotated images and the original image contain the detected objects. Some of the manners in which the spatial filter may be operated are described in greater detail herein below.

The spatial filter module 116 may output information pertaining to the detected images to an output device 118. The output device 118 may comprise, for instance, a display on which the image is shown with the locations of the detected objects. In addition, or alternatively, the output device 118 may comprise, for instance, another machine or program configured to employ the detected object information. By way of example, the output device 118 may comprise an object recognition program, such as, an image quality evaluation program, a human identification program, a guidance system for a robotic device, etc. As a further example, the output device 118 may comprise one or more of the components described hereinabove with respect to the input device 106, and may, in certain instances, comprise the input device 106.

With reference now to FIG. 1B, there is shown a block diagram 150 of an object detection system 152. It should be understood that the following description of the block diagram 150 is but one manner of a variety of different manners in which such an object detection system 152 may be configured. In addition, it should be understood that the object detection system 152 may include additional elements and that some of the elements described herein may be removed and/or modified without departing from a scope of the object detection system 152. For instance, the object detection system 152 may include additional input devices, output devices, modules, memories, etc.

The object detection system 152 contains many of the same elements as set forth herein above with respect to the object detection system 102 depicted in FIG. 1A. As such, detailed descriptions of the elements having the same reference numerals as those elements illustrated in the object detection system 102 of FIG. 1A will not be provided with respect to the object detection system 152. Instead, the descriptions set forth hereinabove for those common elements are relied upon as providing sufficient disclosure for an adequate understanding of those elements.

One major distinction between the object detection system 152 depicted in FIG. 1B and the object detection system 102 depicted in FIG. 1A is that the objection detection system 152 includes a cropping module 154. The cropping module 154 is generally configured to crop out or otherwise distinguish which objects detected by the object detection module 114 are the potential predetermined objects that are to be detected. Although the cropping module 154 is depicted as being included in the controller 104, the cropping module 154 may comprise an algorithm stored in the memory 110, which the controller 104 may access and execute. In addition, the cropping module 114 may comprise any reasonably suitable conventional algorithm capable of cropping various images. The cropping module 154 may further comprise other software or hardware configured to perform the various cropping functions described herein.

The object detection module 114 in the object detection system 152 may be set to detect predetermined objects with a relatively high degree of accuracy while sacrificing the possibility of increased false alarm rates. The reason for this type of setting is that through implementation of the spatial filter module 116, the false alarms may be filtered out of the detected results.

In any regard, in the object detection system 152, the regions containing the potential predetermined objects cropped out by the cropping module 154 may be rotated by the image rotation module 112. The image rotation module 112 in the object detection system 152 may be configured to rotate these regions to one or more angles with respect to their original positions. Thus, for instance, the image rotation module 112 may be configured to rotate the cropped regions in an in-plane direction in increments of about 1 to 5° from the original orientation of the image in either clockwise or counterclockwise directions. The number of cropped region rotation increments may be based, for instance, upon the desired level of accuracy in detecting the predetermined objects. Thus, the greater the number of cropped region rotation increments, the greater the level of accuracy in detecting the predetermined objects. However, in certain instances, cropped regions that are rotated to a relatively high angle may actually reduce the accuracy in detecting objects due to the possibility that the object detection module 152 may be unable to accurately detect the objects in these rotated cropped regions. In this regard, the number of cropped region rotation increments may be determined based on the specific detection feature of the underlying object detection module 114 and may, for instance, be around 1-5 increments.

Another distinction between the object detection systems 102, 152 is that the object detection system 152 includes a second object detection module 156 configured to detect a potential object in a rotated cropped region of the image. The second object detection module 156 may comprise the object detection module 114. Alternatively, the second object detection module 156 may comprise an entirely different object detection module configured to detect predetermined objects in images. In the event the second object detection module 156 comprises the object detection module 114, the second object detection module 156 may comprise different parameter configurations from the object detection module 114.

The controller 104 may employ the second object detection module 156 to detect predetermined objects in the cropped regions that have been rotated by the image rotation module 112. The cropped regions may be inputted into the spatial filter module 116. The spatial filter module 116 may compare the cropped regions, two or more of the rotated and original cropped regions, to determine which of the cropped regions contain the detected objects. If the objects are detected in a plurality of cropped regions, for instance, in both the original cropped region and a rotated cropped region or in multiple rotated cropped regions, the spatial filter 116 may output an indication that the objects have been accurately detected. However, for greater accuracy, the spatial filter module 116 may determine in which of a plurality of rotated cropped regions, and in certain instances the original cropped region, the objects have been detected. As described hereinabove with respect to the object detection system 102, the spatial filter module 116 may output information pertaining to the detected cropped regions to the output device 118.

In one respect, the object detection system 152 may be capable of detecting the predetermined objects at greater speeds relative to the object detection system 102. This may be true because the object detection system 152 may have less data to process as compared with the object detection system 102 because the object detection system 152 mainly processes the cropped portions of an image.

The spatial filter module 116 will now be described in greater detail. In general, the spatial filter module 116 is configured to find consistency among the results detected by either of the object detection modules 114, 156 based upon multiple rotated versions of images or cropped regions. In a first example, the spatial filter module 116 is based upon a concept that a real predetermined object in an original image (I) is likely to be detected on rotated images (Rₘ(I)), where m=1, 2, . . . , n. This example is also based upon the concept that false alarms or false positives of the predetermined objects are unlikely to be detected in an original image (I) and rotated images (Rₘ(I)). This is true because the false alarms may be considered as random signals which are less likely to be consistently detected in multiple rotated images.

In FIGS. 1A and 1B, the results detected by the object detection module 114, 156 from each of the images, both the original image and rotated images, may include multiple objects. The multiple objects may be decomposed as Oₘ={Oₘ(1), Oₘ(2), . . . , Oₘ(n)}. In this example, prior to executing the spatial filter module 116, each of the detected objects Oₘ(j), where m denotes the image at various angles, and j denotes each of the objects, is first mapped back to the original image so that their spatial relationships may be compared. For each detected object Oₘ(j), the spatial filter module 116 searches in the detection results Oₖ, k≠m, in an attempt to find corresponding detection results that refer to the same object that is represented by Oₘ(j). In this process, a consistency vector {v₁, v₂, . . . , vₙ} is generated (for each object “j”) such that if a corresponding detection result is found on rotated image Rₘ(I), the vector component vₘ is set to one, otherwise the vector component vₘ is set to zero. The final spatial filter module 116 output is determined by a weighted sum:
sum=w₁*v₁+w₂*v₂+ . . . +wₙ*vₙ.
The final output of the spatial filter module 116 is considered a valid detection if the value of “sum” is greater than a threshold “t”. Otherwise, if the value of “sum” is less than the threshold “t”, the detection may be considered as a false alarm. The weights {w₁, w₂, . . . , wn} and the corresponding threshold “t” may be set by using any suitable conventional machine learning algorithm, such as, for instance, Adaboost, as disclosed in Y. Freund and R. Schapire, “A Short Introduction to Boosting”, Journal of Japanese Society for Artificial Intelligence, pp. 771-780, September 1999, the disclosure of which is hereby incorporated by reference in its entirety.

In addition, or alternatively, each component of the consistency vector {v₁, v₂, . . . , vn} may comprise a real-valued confidence indicator generated by the underlying object detection module 114, 156. In addition, a weighted sum for each of the components may also be calculated by the underlying object detection module 114, 156.

In a second example, the spatial filter module 116 is based upon various heuristic designs. These heuristic designs may be characterized as “1-or”, “1-and”, and “2-or” filters. The “1-or” filter may be defined as:
OD(R(I,a))∥OD(R(I,−a)).
The “1-and” filter may be defined as:
OD(R(I,a)) && OD(R(I,−a)).
The “2-or” filter may be defined as:
[OD(R(I,a)) && OD(R(I,−a))]∥[OD(R(I,−2a)) && OD(I,−a)]∥[OD(R(I,2a)) && OD(I,a)].

In each of the filters described above, the image or a cropped region of an image is represented by “I”, “R(I, a)” represents a rotated version of the image or the cropped region by “a” degree, where “a” is a predefined parameter that determines the degree of rotation, the “&&” is an “and” operator, and the “∥” is an “or” operator. The “OD( )” represents the object detection module 114, 156 that returns a binary output. The binary output may include, for instance, OD(R(I, a))=1, which indicates that an object is detected in the rotated image that has a size similar to the original detected object region. Otherwise OD(R(I, a))=0 indicates that an object has not been detected in the rotated image that has a size similar to the original detected object.

By way of example with respect to the “1-and” filter, if d0 is a potential object in the original image or a cropped region of the original image, d1 is a potential object in the image or cropped region rotated to an angle “a” and d2 is a potential object in the image or cropped region rotated to an angle “−a”, an object may be determined as being correctly detected if d1=1 or if d2=1. More particularly, d1 may equal 1 if a comparison between d1 and d0 indicates that d1 has a size similar to d0. In addition, d2 may equal 1 if a comparison between d2 and d0 indicates that d2 has a size similar to d0. Otherwise, if both d1 and d2 equal 0, then the potential object detected as d0 may be considered as a false alarm.

As an example of the “1-and” filter, an object may be determined as being correctly detected if d1 and d2 both equal 1. Thus, if either d1 or d2 equal 0, then the potential objected detected as d0 may be considered as a false alarm.

By way of example with respect to the “2-or” filter, d3 is a potential object in the image or cropped region rotated to another angle “−2a” and d4 is a potential object in the image or cropped region rotated to another angle “2a”. In this filter, an object may be determined as being correctly detected if d1 and d2 equal 1, d3 and d2 equal 1, d4 and d1 equal 1, d2 and d4 equal 1, d3 and d4 equal 1, or if d3 and d1 equal one.

Although the various filters were described above with particular numbers of rotated images or cropped regions of images, it should be appreciated that these filters may function with any reasonably suitable number of rotated images or cropped regions of images. In this regard, the examples of the filters described herein above are not meant to be limited to the number of rotated images or cropped regions of images described, but instead, may used with any suitable number of rotated images or cropped regions of images.

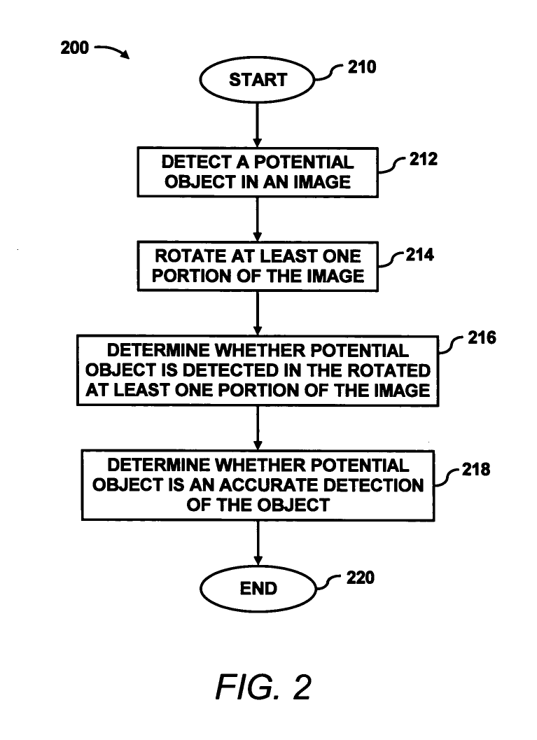

FIG. 2 illustrates a flow diagram of an operational mode 200 of a method for detecting objects in images. It is to be understood that the following description of the operational mode 200 is but one manner of a variety of different manners in which the operational mode 200 be practiced. It should also be apparent to those of ordinary skill in the art that the operational mode 200 represents a generalized illustration and that other steps may be added or existing steps may be removed, modified or rearranged without departing from a scope of the operational mode 200.

The description of the operational mode 200 is made with reference to the block diagrams 100 and 150 illustrated in FIGS. 1A and 1B, respectively, and thus makes reference to the elements cited therein. It should, however, be understood that the operational mode 200 is not limited to the elements set forth in the block diagrams 100 and 150. Instead, it should be understood that the operational mode 200 may be practiced by an object detection system having a different configuration than that set forth in the block diagrams 100 and 150.

The operational mode 200 may be manually initiated at step 210 through an instruction received by the controller 104 from a user. Alternatively, the operational mode 200 may be initiated following a predetermined period of time, in response to receipt of various signals, through detection of an input device 106, etc. In any respect, at step 212, a potential object may be detected in an image. The potential object may comprise a predetermined object that the controller 104 is programmed to detect.

At step 214, at least a portion of the image may be rotated. More particularly, one or more cropped regions or the entire image may be rotated at step 214. The manners in which the at least one portion of the image may be rotated are described in greater detail hereinabove with respect to the image rotation module 112.

At step 216, it may be determined whether the potential object is detected in the rotated at least one portion of the image. As described herein above, the detection of the potential object in the at least one portion of the image may be performed by a different object detection module from the object detection module used to detect the potential object at step 212, or it may be performed by the same object detection module. If the same object detection module is used, the object detection module may have different parameter configurations to detect the potential object in the rotated at least one portion of the image. Based upon the determination of whether the potential object is detected in the rotated at least one portion of the image, a determination of whether the potential object is an accurate detection of the object may be made as indicated at step 218.

The operational mode 200 may end as indicated at step 220. The end condition may be similar to an idle mode for the operational mode 200 since the operational mode 200 may be re-initiated, for instance, when another image is received for processing.

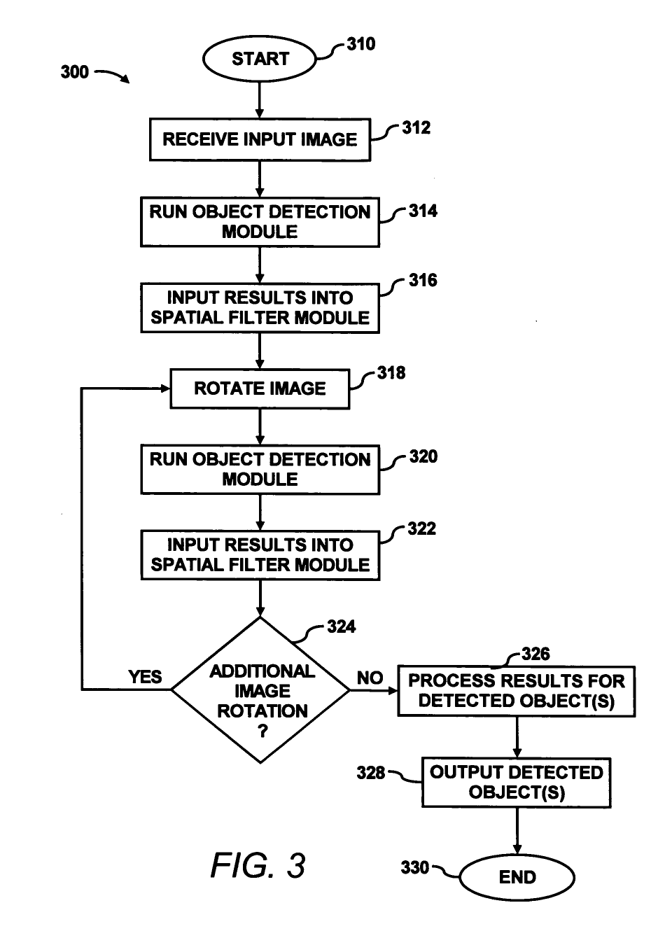

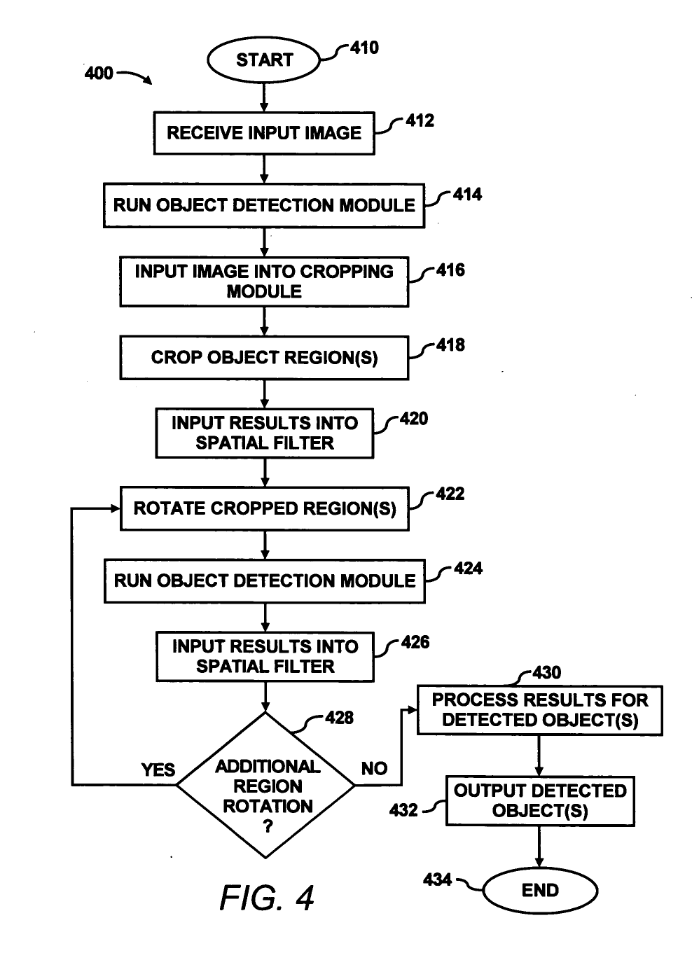

Additional steps that may be employed with the operational mode 200 are described with respect to FIGS. 3 and 4 below.

FIG. 3 illustrates a flow diagram of an operational mode 300 of a method for detecting objects in images. It is to be understood that the following description of the operational mode 300 is but one manner of a variety of different manners in which the operational mode 300 may be practiced. It should also be apparent to those of ordinary skill in the art that the operational mode 300 represents a generalized illustration and that other steps may be added or existing steps may be removed, modified or rearranged without departing from a scope of the operational mode 300.

The description of the operational mode 300 is made with reference to the block diagram 100 illustrated in FIG. 1A, and thus makes reference to the elements cited therein. It should, however, be understood that the operational mode 300 is not limited to the elements set forth in the block diagram 100. Instead, it should be understood that the operational mode 300 may be practiced by an object detection system having a different configuration than that set forth in the block diagram 100.

The operational mode 300 may be manually initiated at step 310 through an instruction received by the controller 104 from a user. Alternatively, the operational mode 300 may be initiated following a predetermined period of time, in response to receipt of various signals, through detection of an input device 106, etc. In addition, at step 312, the controller 104 may receive input image data from the input device 106. Various manners in which the controller 104 may receive the image data are described in greater detail hereinabove with respect to FIG. 1A.

At step 314, the controller 104 may run the object detection module 114 to detect potential predetermined objects in the image represented by the image data received at step 312. More particularly, the object detection module 114 may be programmed or otherwise configured to detect the predetermined objects in an image. Thus, the object detection module 114 may process the image to determine the locations or regions in the image where the potential objects are located. In one respect, the object detection module 114 may operate to create boxes or other identification means around the potential objects to note their locations or regions in the image. The results of the object detection module 114 may be inputted into the spatial filter module 116, as indicated at step 316.

The input image may also be rotated by the image rotation module 112 as indicated at step 318. As described hereinabove, the image rotation module 112 may rotate the image in an in-plane direction in an increment of about 1 to 5 degrees from the original orientation of the image in either clockwise or counterclockwise directions. Thus, the input image may be rotated to a first angle by the image rotation module 112. In addition, the controller 104 may run the object detection module 114 to detect potential predetermined objects in the rotated image at step 320. As in step 314, the object detection module 114, or a different object detection module (not shown), may be configured to process the rotated image to determine the locations or regions in the rotated image where the potential objects are located. Again, the object detection module 114, or the different object detection module, may create boxes or other identification means around the potential objects to note their locations or regions in the rotated image. The results of the object detection module 114 are again inputted into the spatial filter module 116, at step 322.

The object detection module may store the results in the memory 110, such that the results may be accessed by the spatial filter module 116 to process the images as described below. In this regard, at steps 316 and 322, instead of inputting the results into the spatial filter module 116, the results may be inputted into the memory 110.

At step 324, the controller 104 may determine whether additional object detections on rotated images are to be obtained. This determination may be based upon the desired level of accuracy in detecting objects in an image. For instance, a larger number of rotated images, within prescribed limits, may be analyzed for greater accuracy in detecting the desired objects. Alternatively, a lesser number of rotated images may be analyzed for faster object detection processing. The controller 104 may be programmed with the number of rotated images to be analyzed and thus may determine whether an additional image rotation is to be obtained based upon the programming. In addition, the number of image rotation increments may be determined based on the specific detection feature of the underlying object detection module 114 and may, for instance, be around 1-5 increments.

If the controller 104 determines that an additional image rotation is required, steps 318-324 may be repeated. In addition, steps 318-324 may be repeated until the controller 104 determines that a predetermined number of rotated images have been processed. At that time, which is equivalent to a “no” condition at step 324, the spatial filter 116 may process the results of objection detection module 114 for the one or more rotated images at step 226. More particularly, the spatial filter module 116 may compare the various results to determine the locations of the predetermined objects in the original image and to remove false alarms or false positives from the detection results. A more detailed description of various manners in which the spatial filter 116 may operate to make this determination is set forth hereinabove.

The results from the spatial filter module 116 may also be outputted to the output device 118 at step 328. In one regard, the output device 118 may comprise a display device and may be used to display the locations of the detected predetermined objects. In another regard, the output device 118 may comprise another device or program configured to use the detected predetermined object information.

The operational mode 300 may end as indicated at step 330. The end condition may be similar to an idle mode for the operational mode 300 since the operational mode 300 may be re-initiated, for instance, when the controller 104 receives another input image to process.

FIG. 4 illustrates a flow diagram of an operational mode 400 of another method for detecting objects in images. It is to be understood that the following description of the operational mode 400 is but one manner of a variety of different manners in which the operational mode 400 be practiced. It should also be apparent to those of ordinary skill in the art that the operational mode 400 represents a generalized illustration and that other steps may be added or existing steps may be removed, modified or rearranged without departing from a scope of the operational mode 400.

The description of the operational mode 400 is made with reference to the block diagram 150 illustrated in FIG. 1B, and thus makes reference to the elements cited therein. It should, however, be understood that the operational mode 300 is not limited to the elements set forth in the block diagram 150. Instead, it should be understood that the operational mode 400 may be practiced by an object detection system having a different configuration than that set forth in the block diagram 150.

The operational mode 400 may be manually initiated at step 410 through an instruction received by the controller 104 from a user. Alternatively, the operational mode 400 may be initiated following a predetermined period of time, in response to receipt of various signals, through detection of an input device 106, etc. In addition, at step 412, the controller 104 may receive input image data from the input device 106. Various manners in which the controller 104 may receive the image data are described in greater detail hereinabove with respect to FIG. 1A.

At step 414, the controller 104 may run the object detection module 114 to detect potential predetermined objects in the image represented by the image data received at step 412. More particularly, the object detection module 114 may be programmed or otherwise configured to detect the predetermined objects in an image. Thus, the object detection module 114 may process the image to determine the locations or regions in the image where the potential objects are located. In one respect, the object detection module 114 may operate to create boxes or other identification means around the potential objects to note their locations or regions in the image. The results of the object detection module 114 may be inputted into the cropping module 154, as indicated at step 416.

At step 418, the cropping module 154 may crop the regions detected as being potential predetermined objects by the object detection module 114. In addition, the cropping module may input the cropped regions into the spatial filter module 116, at step 420. The cropping module may also input the cropped regions into the image rotation module 112. At step 422, the image rotation module 112 may rotate the cropped regions. As described hereinabove, the image rotation module 112 may rotate the cropped regions in an in-plane direction in an increment of about 1 to 5 degrees from the original orientation of the cropped regions in either clockwise or counterclockwise directions. Thus, the cropped regions may be rotated to a first angle by the image rotation module 112 at step 422.

The rotated cropped regions may be inputted into the object detection module 156, which, as described hereinabove, may comprise the object detection module 114 or a separate object detection module. In addition, the object detection module 156 may be run to determine whether the rotated cropped regions each contain a potential detected object at step 424. The object detection module 156 may be configured to remove the boxes or other identification means from those cropped regions where the potential predetermined objects are not detected by the object detection module 156. In addition, the object detection module 156 may be configured to input the results of the object detection into the spatial filter 116 at step 426.

The object detection module 114, 156 may store the results of respective object detections in the memory 110, such that the results may be accessed by the spatial filter module 116 to process the images as described below. In this regard, at steps 420 and 426, instead of inputting the results into the spatial filter module 116, the results may be inputted into the memory 110.

At step 428, the controller 104 may determine whether additional object detections on rotated cropped regions are to be obtained. This determination may be based upon the desired level of accuracy in detecting objects in an image. For instance, a larger number of rotated cropped regions, within prescribed limits, may be analyzed for greater accuracy in detecting the desired objects. Alternatively, a lesser number of rotated cropped regions may be analyzed for faster object detection processing. The controller 104 may be programmed with the number of rotated cropped regions to be analyzed and thus may determine whether an additional cropped region rotation is to be obtained based upon the programming. In addition, the number of image rotation increments may be determined based on the specific detection feature of the underlying object detection module 114 and may, for instance, be around 1-5 increments.

If the controller 104 determines that an additional cropped region rotation is required, steps 422-428 may be repeated. In addition, steps 422-428 may be repeated until the controller 104 determines that a predetermined number of rotated cropped region have been processed. At that time, which is equivalent to a “no” condition at step 428, the spatial filter 116 may process the results of objection detection modules 114, 156 for the one or more rotated cropped regions at step 430. More particularly, the spatial filter module 116 may compare the various results to determine the locations of the predetermined objects in the original image and to remove false alarms or positives from the detection results. A more detailed description of various manners in which the spatial filter 116 may operate to make this determination is set forth hereinabove.

The results from the spatial filter module 116 may also be outputted to the output device 118 at step 432. In one regard, the output device 118 may comprise a display device and may be used to display the locations of the detected predetermined objects. In another regard, the output device 118 may comprise another device or program configured to use the detected predetermined object information.

The operational mode 400 may end as indicated at step 434. The end condition may be similar to an idle mode for the operational mode 400 since the operational mode 400 may be re-initiated, for instance, when the controller 104 receives another input image to process.

The operations illustrated in the operational modes 200, 300, and 400 may be contained as a utility, program, or a subprogram, in any desired computer accessible medium. In addition, the operational modes and 200, 300, and 400 may be embodied by a computer program, which can exist in a variety of forms both active and inactive. For example, they can exist as software program(s) comprised of program instructions in source code, object code, executable code or other formats. Any of the above can be embodied on a computer readable medium, which include storage devices and signals, in compressed or uncompressed form.

Exemplary computer readable storage devices include conventional computer system RAM, ROM, EPROM, EEPROM, and magnetic or optical disks or tapes. Exemplary computer readable signals, whether modulated using a carrier or not, are signals that a computer system hosting or running the computer program can be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that any electronic device capable of executing the above-described functions may perform those functions enumerated above.

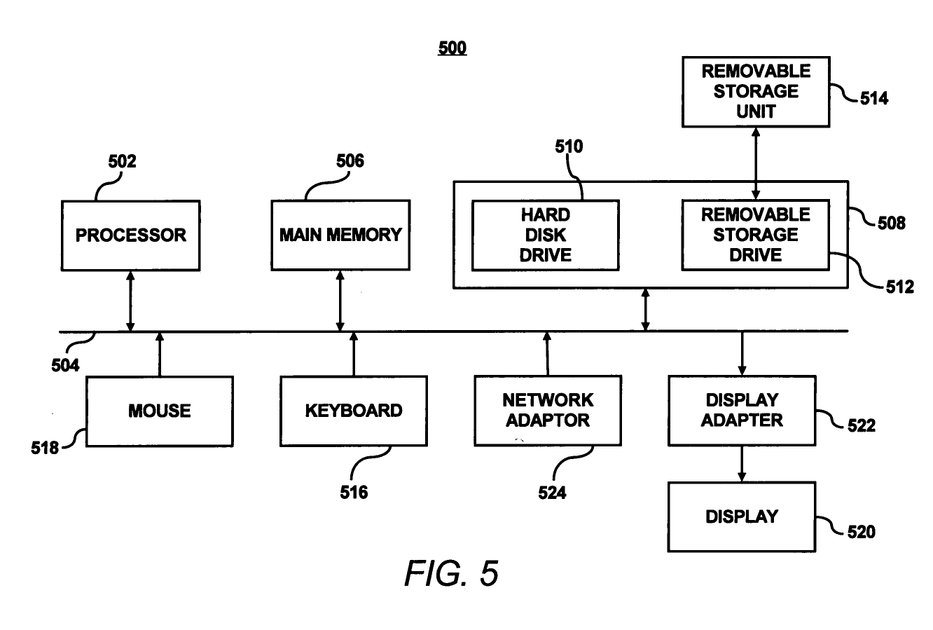

FIG. 5 illustrates a computer system 500, which may be employed to perform the various functions of the object detection systems 102 and 152 described hereinabove. In this respect, the computer system 500 may be used as a platform for executing one or more of the functions described hereinabove with respect to the object detection systems 102 and 152.

The computer system 500 includes one or more controllers, such as a processor 502. The processor 502 may be used to execute some or all of the steps described in the operational modes 200, 300, and 400. In this regard, the processor 502 may comprise the controller 104. Commands and data from the processor 502 are communicated over a communication bus 504. The computer system 500 also includes a main memory 506, such as a random access memory (RAM), where the program code for, for instance, the object detection systems 102 and 152, may be executed during runtime, and a secondary memory 508. The main memory 506 may, for instance, comprise the memory 110 described hereinabove.

The secondary memory 508 includes, for example, one or more hard disk drives 510 and/or a removable storage drive 512, representing a floppy diskette drive, a magnetic tape drive, a compact disk drive, etc., where a copy of the program code for the object detection system 102, 152 may be stored. The secondary memory 508 may comprise the input device 106 and/or the output device 118. In addition, although not shown, the input device 106 may comprise a separate peripheral device, such as, for instance, a camera, a scanner, etc. The input device 106 may also comprise a network, such as, the Internet.

The removable storage drive 512 reads from and/or writes to a removable storage unit 514 in a well-known manner. User input and output devices may include a keyboard 516, a mouse 518, and a display 520, which may also comprise the output device 118. A display adaptor 522 may interface with the communication bus 504 and the display 520 and may receive display data from the processor 502 and convert the display data into display commands for the display 520. In addition, the processor 502 may communicate over a network, for instance, the Internet, LAN, etc., through a network adaptor 524.

It will be apparent to one of ordinary skill in the art that other known electronic components may be added or substituted in the computer system 500. In addition, the computer system 500 may include a system board or blade used in a rack in a data center, a conventional “white box” server or computing device, etc. Also, one or more of the components in FIG. 5 may be optional (for instance, user input devices, secondary memory, etc.).

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims—and their equivalents—in which all terms are meant in their broadest reasonable sense unless otherwise indicated.

What is claimed is:

1. A method for detecting a predetermined object in an image, said method comprising:
detecting a potential predetermined object in the image;
rotating at least one portion of the image;
determining whether the potential predetermined object is detected in the rotated at least one portion of the image; and
determining whether the potential predetermined object is an accurate detection of the predetermined object in response to a determination of whether the potential predetermined object is detected in the rotated at least one portion of the image.

2. The method according to claim 1, wherein the step of determining whether the potential predetermined object is an accurate detection of the predetermined object comprises comparing the sizes of the potential predetermined object in the image and the potential predetermined object detected in the rotated at least one portion of the image, said method further comprising:
outputting an indication that the potential predetermined object is an accurate detection of the predetermined object in response to the comparison indicating that the sizes of the potential predetermined object in the image and the potential predetermined object in the rotated at least one portion of the image are substantially similar; and
outputting an indication that the potential predetermined object is an a false alarm in response to the comparison indicating that the sizes of the potential predetermined object in the image and the potential predetermined object in the rotated at least one portion of the image are dissimilar.

3. The method according to claim 1, further comprising:
outputting an indication that the potential predetermined object is an accurate detection of the predetermined object in response to the potential predetermined object being detected in the rotated at least one portion of the image.

4. The method according to claim 1, further comprising:
outputting an indication that the potential predetermined object is a false alarm in response to the potential predetermined object not being detected in the rotated at least one portion of the image.

5. The method according to claim 1, further comprising:
rotating the at least one portion of the image to a plurality of angles;
detecting whether the potential predetermined object is detected in one or more of the plurality of rotated at least one portions of the images; and
determining whether the potential predetermined object is an accurate detection of the predetermined object in response to detecting whether the potential predetermined object is detected in one or more of the plurality of rotated at least one portions of the images.

6. The method according to claim 5, wherein the step of determining whether the potential predetermined object is an accurate detection of the predetermined object further comprises determining whether a sum of a plurality of weighted consistency vectors pertaining to the one or more of the plurality of rotated at least one portions of the images is greater than a predetermined threshold, said method further comprising:
outputting an indication that the potential predetermined object is an accurate detection of the predetermined object in response to the sum of the plurality of weighted consistency vectors being greater than the predetermined threshold.

7. The method according to claim 6, wherein the step of determining whether a sum of a plurality of weighted consistency vectors further comprises setting a consistency vector pertaining to a detection result for a rotated at least one portion of the image at one of the plurality of angles to one in response to the potential predetermined object being detected in the rotated at least one portion of the image at the one of the plurality of angles and setting a consistency vector pertaining to a detection result for a rotated at least one portion of the image at one of the plurality of angles to zero in response to the potential predetermined object not being detect in the rotated at least one portion of the image at the one of the plurality of angles.

8. The method according to claim 5, wherein the step of determining whether the potential predetermined object is an accurate detection of the predetermined object further comprises determining whether the potential predetermined object is detected in one or more of the plurality of rotated at least one portions of the images, said method further comprising:
outputting an indication that the potential predetermined object is an accurate detection of the predetermined object in response to the potential predetermined object being detected in one or more of the plurality of rotated at least one portions of the images.

9. The method according to claim 1, further comprising:
cropping a region in the image containing the potential predetermined object, wherein the step of rotating at least one portion of the image comprises rotating the cropped region of the image.

10. The method according to claim 9, wherein the step of determining whether the potential predetermined object is an accurate detection of the predetermined object further comprises determining whether the potential predetermined object is detected in the rotated cropped region of the image, said method further comprising:
outputting an indication that the potential predetermined object is an accurate detection of the predetermined object in response to the potential predetermined object being detected in the rotated cropped region of the image.

11. The method according to claim 1, further comprising:
outputting to an output device an indication of whether the detected potential predetermined object in the image is an accurate detection of the predetermined object.

12. An object detection system comprising:
an object detection module configured to detect a potential predetermined object in an image;
an image rotation module configured to rotate at least one portion of the image;
said object detection module being configured to detect the potential predetermined object in the rotated at least one portion of the image;
a spatial filter module configured to compare detection results from the object detection module of the image and the rotated at least one portion of the image to determine whether the potential predetermined object detected by the object detection module is an accurate detection of the predetermined object.

13. The object detection system according to claim 12, wherein the spatial filter module is configured to output a determination that the potential predetermined object detected by the object detection module is an accurate detection of the predetermined object if the potential predetermined object is detected in the rotated at least one portion of the image.

14. The object detection system according to claim 12, wherein the spatial filter module is configured to output a determination that the potential predetermined object detected by the object detection module is a false alarm if the potential predetermined object is not detected in the rotated at least one portion of the image.

15. The object detection system according to claim 12, wherein said image rotation module is configured to rotate the at least one portion of the image to a plurality of angles, wherein the object detection module is configured to detect the potential predetermined object in the at least one portion of the images rotated to the plurality of angles, and wherein the spatial filter module is configured to compare detection results from the object detection module of the image and the at least one portion of the images rotated to the plurality of angles to determine whether the potential predetermined object detected by the object detection module is an accurate detection of the predetermined object.

16. The object detection system according to claim 15, wherein the spatial filter module is configured to output and indication that the potential predetermined object detected by the object detection module is an accurate detection of the predetermined object if the following equations are satisfied:
sum=w₁*v₁+w₂*v₂+ . . . +wₙ*vₙ, and sum>t,
where w₁, w₂, . . . , wₙ are weights, v₁, v₂, . . . , vₙ are consistency vectors determined through a comparison between the detection results of the image and the at least one portion of the images rotated to the plurality of angles, and t is a predetermined threshold value.

17. The object detection system according to claim 16, wherein the consistency vector v₁, v₂, . . . , vₙ for a vector component vₘ of a detection result for a rotated at least one portion of the image at one of the plurality of angles is set to one if the potential predetermined object is detected in both the image and the at least one portion of the image rotated to the one of the plurality of angles, otherwise the consistency vector v₁, . . . , vₙ for a vector component vₘ is set to zero.

18. The object detection module according to claim 15, wherein the spatial filter module is configured to output an indication that the potential predetermined object detected by the object detection module is an accurate detection of the predetermined object if the potential predetermined object detected by the object detection module is detected in at least one of the at least one portion of the images rotated to the plurality of angles.

19. The object detection module according to claim 15, wherein the spatial filter module is configured to output an indication that the potential predetermined object detected by the object detection module is an accurate detection of the predetermined object if the potential predetermined object detected by the object detection module is detected in a plurality of the at least one portions of the images rotated to the plurality of angles.

20. The object detection module according to claim 12, further comprising:
a cropping module configured to crop a region in the image containing a potential predetermined object detected by the object detection module, wherein the at least one portion of the image comprises a cropped region of the image.

21. The object detection module according to claim 20, further comprising:
another object detection module configured to detect the potential predetermined object in a rotated cropped region of the image; and
wherein the spatial filter module is configured to compare detection results from the object detection module and the another object detection module to determine whether the potential predetermined object detected by the object detection module is an accurate detection of the predetermined object.

22. The object detection module according to claim 12, further comprising:
an input module configured to receive the image from an input device.

23. The object detection module according to claim 12, further comprising:
an output module configured to receive an output indication from the spatial filter.

24. A spatial filter for use with an object detection algorthim, said spatial filter comprising:
means for comparing detection results from the object detection algorithm, wherein the object detection algorithm is configured to detect a potential predetermined object in an image and to detect the potential predetermined object in at least one portion of the image rotated to an angle; and
means for determining whether the potential predetermined object detected by the object detection module is an accurate detection of the predetermined object based upon the results of the means for comparing.

25. The spatial filter according to claim 24, further comprising:
means for outputting a determination that the potential predetermined object detected by the object detection algorithm is an accurate detection of the predetermined object if the means for comparing determines that the potential predetermined object is detected in the at least one portion of the image rotated to the angle.

26. The spatial filter according to claim 24, wherein the means for determining is further configured to determine that the potential predetermined object detected by the object detection algorithm is an accurate detection of the predetermined object if the means for comparing determines that a sum of a plurality of weighted consistency vectors is greater than a predetermined threshold.

27. The spatial filter according to claim 24, wherein the means for determining is further configured to determine that the potential predetermined object detected by the object detection algorithm is an accurate detection of the predetermined object if the means for comparing determines that the potential predetermined object detected by the object detection algorithm is detected in one or more of the at least one portions of the images rotated to a plurality of angles.

28. A computer readable storage medium on which is embedded one or more computer programs, said one or more computer programs implementing a method for detecting an object in an image, said one or more computer programs comprising a set of instructions for:
detecting a potential predetermined object in the image;
rotating at least one portion of the image;
detecting whether the potential predetermined object is detected in the rotated at least one portion of the image;
outputting an indication that the potential predetermined object detected in the image is an accurate detection of the predetermined object in response to the potential predetermined object being detected in the rotated at least one portion of the image.

29. The computer readable storage medium according to claim 28, said one or more computer programs further comprising a set of instructions for:
rotating the at least one portion of the image to a plurality of angles;
detecting whether the potential predetermined object is detected in one or more of the plurality of rotated at least one portions of the images; and
outputting an indication that the potential predetermined object detected in the image is an accurate detection of the predetermined object in response to the potential predetermined object being detected in at least one of the plurality of rotated at least one portions of the images.

30. The computer readable storage medium according to claim 28, said one or more computer programs further comprising a set of instructions for:
cropping a region in the image containing the potential predetermined object, wherein the step of rotating at least one portion of the image comprises rotating the cropped region of the image.
